(19) United States
(12) Patent Application Publication
(10) Pub. No.: US 2026/0304301 A1
(43) Pub. Date: Oct. 1, 2026

(54) CONTEXT-AWARE WIRELESS NETWORK SELECTION FOR A VEHICLE

(71) Applicant: QUALCOMM Incorporated, San Diego, CA (US)

(72) Inventors: Mohammad Nekoui, Escondido, CA (US); Soumya Das, San Diego, CA (US)

(21) Appl. No.: 19/090,020

(22) Filed: Mar. 25, 2025

(51) Int. Cl. H04W 48/18; H04W 4/44; H04W 84/12

(52) U.S. Cl. CPC H04W 48/18; H04W 4/44; H04W 84/12

(57) ABSTRACT

An apparatus includes a processing system configured to receive vehicle environmental context data associated with an environment of a vehicle and to receive vehicle operation data associated with one or more operating conditions of the vehicle. The processing system is further configured to generate, in accordance with the vehicle environmental context data and the vehicle operation data, a stationarity index value associated with the vehicle. The stationarity index value indicates whether the vehicle is predicted to be stationary for at least a threshold time interval to enable selection of a wireless network for communication by the vehicle. The processing system is further configured to initiate communication using one of a wireless wide area network (WWAN) or a wireless local area network (WLAN) as the wireless network. The wireless network selected in accordance with the stationarity index value and further in accordance with one or more radio access technology (RAT) parameters.

### TECHNICAL FIELD

Aspects of the present disclosure relate generally to wireless communication networks, and more particularly, to selection of wireless communication networks for vehicles.

### INTRODUCTION

User equipment (UE) devices include a variety of electronic devices that communicate with cellular networks. Such UE devices may include cellular phones, such as smart phones. Further, UE devices include other types of UEs, such as wearable devices (e.g., smart watches), Internet-of-Things (IoT) devices, and onboard vehicle systems, such as advanced driver-assistance systems (ADAS).

In some circumstances, a UE may switch from a cellular network to a wireless local area network (WLAN). For example, if a UE detects that connecting to a WLAN would improve performance as compared to a cellular network (such as by increasing a data rate or by reducing power consumption of the UE), the UE may initiate a switch from using the cellular network to using the WLAN. The switch may be referred to as a handoff or handover. Use of the WLAN may be more efficient than use of the cellular network in some cases. For example, a WLAN may be associated with improved performance, increased network stability, and reduced latency as compared to a cellular network.

In some circumstances, performing such a switch may be inefficient. For example, if a UE rapidly enters and then leaves a coverage area of a WLAN, connecting to the WLAN may increase power consumption and device resource utilization for the UE while offering relatively little performance improvement for the UE. Accordingly, there exists a need for a system that takes such considerations into account in making an intelligent switch decision.

### BRIEF SUMMARY OF SOME EXAMPLES

The systems, methods and devices of this disclosure each have several innovative aspects, no single one of which is solely responsible for the desirable attributes disclosed herein.

In some aspects, an apparatus for wireless network selection for a vehicle includes a processing system including one or more processors and one or more memories coupled to the one or more processors. The processing system is configured to receive vehicle environmental context data associated with an environment of the vehicle and to receive vehicle operation data associated with one or more operating conditions of the vehicle. The processing system is further configured to generate, in accordance with the vehicle environmental context data and the vehicle operation data, a stationarity index value associated with the vehicle. The stationarity index value indicates whether the vehicle is predicted to be stationary for at least a threshold time interval to enable selection of a wireless network for communication by the vehicle. The processing system is further configured to initiate communication using one of a wireless wide area network (WWAN) or a wireless local area network (WLAN) as the wireless network. The wireless network selected in accordance with the stationarity index value and further in accordance with one or more radio access technology (RAT) parameters.

In some further aspects, a method of wireless network selection for a vehicle includes receiving vehicle environmental context data associated with an environment of the vehicle and receiving vehicle operation data associated with one or more operating conditions of the vehicle. The method further includes generating, in accordance with the vehicle environmental context data and the vehicle operation data, a stationarity index value associated with the vehicle. The stationarity index value indicates whether the vehicle is predicted to be stationary for at least a threshold time interval to enable selection of a wireless network for communication by the vehicle. The method further includes communicating using one of a wireless wide area network (WWAN) or a wireless local area network (WLAN) as the wireless network. The wireless network is selected in accordance with the stationarity index value and further in accordance with one or more radio access technology (RAT) parameters.

In some additional aspects, a non-transitory computer-readable medium stores instructions executable by one or more processors to initiate, perform, or control operations for wireless network selection for a vehicle. The operations include receiving vehicle environmental context data associated with an environment of the vehicle and receiving vehicle operation data associated with one or more operating conditions of the vehicle. The operations further include generating, in accordance with the vehicle environmental context data and the vehicle operation data, a stationarity index value associated with the vehicle. The stationarity index value indicates whether the vehicle is predicted to be stationary for at least a threshold time interval to enable selection of a wireless network for communication by the vehicle. The operations further include communicating using one of a wireless wide area network (WWAN) or a wireless local area network (WLAN) as the wireless network. The wireless network is selected in accordance with the stationarity index value and further in accordance with one or more radio access technology (RAT) parameters.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a diagram illustrating an example of a vehicle that supports context-aware wireless network selection.

FIG. 2 shows a block diagram of an example configuration of a vehicle supporting context-aware wireless network selection.

FIG. 3 is a block diagram illustrating an example wireless network that supports context-aware wireless network selection for a vehicle.

FIG. 4 is a diagram illustrating an example of a multi-stage system that supports context-aware wireless network selection for a vehicle.

FIG. 5 is a diagram illustrating examples of operations that support context-aware wireless network selection for a vehicle.

FIG. 6 is a flow chart illustrating an example method that supports context-aware wireless network selection for a vehicle.

Like reference numbers and designations in the various drawings indicate like elements.

### DETAILED DESCRIPTION

Vehicles increasingly use wireless networks to enable a wide range of features. Such features may include navigation, entertainment, emergency and safety messaging, remote access, remote diagnostics, wireless software updates, and other features that require wireless connectivity. Some such vehicle features may use vehicle-to-everything (V2X) communications, which may include vehicle-to-vehicle (V2V) communications, vehicle-to-infrastructure (V2I) communications, vehicle-to-network (V2N) communications, and vehicle-to-pedestrian (V2P) communications, as illustrative examples.

To facilitate wireless communications, a vehicle may select either a wireless wide area network (WWAN) or a wireless local area network (WLAN). Use of the WWAN may enhance wireless continuity for the vehicle (e.g., where the vehicle can connect to a new network node upon leaving the coverage area of a current network node) but may also be associated with greater power consumption, reduced network stability, and increased latency as compared to the WLAN. Further, although the WLAN may be associated with reduced power consumption, increased network stability, and lower latency as compared to the WWAN, connection to the WLAN may in some cases be temporary, such as if the vehicle is temporarily stopped in the coverage area of a WLAN. In some examples, temporarily connecting to a WLAN may disrupt wireless connectivity for the vehicle and may increase power consumption of the vehicle. Further, if a large quantity of vehicles temporarily connect to the WLAN (such as if the coverage area of the WLAN is near a busy intersection), performance of the WLAN may also be reduced.

Some systems may use hysteresis to avoid such temporary connection. For example, after detecting availability of a WLAN, a vehicle may wait a particular time interval before connecting to the WLAN. However, if the vehicle subsequently leaves the coverage area of the WLAN soon after connecting to the WLAN, such a technique still may be associated with the above-identified problems. Further, use of hysteresis may be relatively inefficient due to preventing the vehicle from rapidly connecting to the WLAN, in which case the vehicle may have to wait the particular time interval before achieving benefits associated with the WLAN, such as reduced power consumption, increased network stability, and lower latency.

Such systems do not intelligently determine whether to switch from a WWAN to a WLAN. For example, such systems do not take into account a wide range of data available to modern vehicles. Such information may include, for example, data from communications received from the vehicle (e.g., signal phase and timing (SPaT) messaging), path planning information used by the vehicle, data from subsystems of the vehicle (such as navigation, speed, or gear position information), and other types of information. Accordingly, there exists a need for a system that takes such considerations into account in making an intelligent switch decision.

Various aspects relate generally to wireless communication for vehicles and more particularly to using information available to a vehicle to make context-aware switch decisions to select a WWAN or a WLAN for communication by the vehicle. In some examples, such a vehicle may use vehicle context information to improve selection of wireless networks for communication. In some examples, the vehicle context information may include vehicle environmental context data associated with an environment of the vehicle, such as sensor data (e.g., image data, radar data, LiDAR data, or other data) or signal phase and timing (SPaT) data. Alternatively, or in addition, the vehicle context information may include receiving vehicle operation data, such as one or more of vehicle communication data, vehicle operation data, vehicle positioning data, or path prediction data associated with the vehicle. Accordingly, a vehicle may take into account a wide range of information that is available to the vehicle in making context-aware switch decisions to select a wireless network.

In some implementations, the vehicle may use a multi-stage system, such as a multi-stage neural network, to process such information and to enable the context-aware switch decisions. A first stage of the multi-stage system may receive the vehicle environmental context data associated with the environment of the vehicle and may determine an environmental context feature vector indicating features of the environment of the vehicle. A second stage of the multi-stage system may receive the environmental context feature vector and the vehicle operation data. In accordance with the environmental context feature vector and the vehicle operation data, a third stage of the multi-stage system may determine a stationarity index value indicating whether the vehicle is predicted to be stationary for at least a threshold time interval to enable selection of a wireless network for communication by the vehicle. To illustrate, in some examples, the stationarity index value may indicate that the vehicle is predicted to remain in motion, such as if the vehicle is traveling on an interstate highway with a relatively large amount of distance until the next exit from the interstate highway. In some other examples, the stationarity index value may indicate that the vehicle is predicted to remain stationary, such as if an ignition of the vehicle is deactivated and a transmission of the vehicle is set to park.

The third stage may use the stationarity index value and one or more radio access technology (RAT) parameters to select one of a WWAN or a WLAN for communication. In some examples, the one or more RAT parameters may include one or more of a WWAN cost parameter associated with the WWAN, a WLAN cost parameter associated with the WLAN, a WWAN performance parameter associated with the WWAN, or a WLAN performance parameter associated with the WLAN.

In a first example, the third stage may be implemented using a mixed strategy Nash equilibrium (MSNE) process. For example, vehicles may probabilistically select among a WWAN and a WLAN based on respective stationarity indices of the vehicles and based on the one or more RAT parameters, where more stationary vehicles are more likely to select the WLAN than the WWAN. The MSNE process may enable an equilibrium condition (or a range of equilibrium-like conditions) in which neither the WWAN nor the WLAN becomes “overwhelmed” with a large quantity of vehicle connections.

In some other implementations, the third stage may be implemented using one or more other techniques. To illustrate, in a second example, the third stage may be implemented using a neural network. The neural network may be trained on a variety of data, which may include locally sourced vehicle data, wireless network condition data, crowd-sourced training data, or a digital twin associated with a vehicle, as illustrative examples. Training the neural network in such a manner may enable the neural network to predict, using the stationarity index and the one or more RAT parameters, whether the vehicle is likely to remain stationary.

Particular aspects of the subject matter described in the disclosure can be implemented to realize one or more of the following advantages. In some examples, the vehicle may achieve improved wireless connectivity by avoiding switching of wireless networks too frequently. For example, by avoiding a handover to a WLAN when the vehicle is not predicted to remain stationary, a situation may be avoided in which the vehicle connects to a WLAN and then leaves a coverage area of the WLAN (and then subsequently reconnects to a WWAN). By predicting whether the vehicle is likely to remain stationary, the vehicle may avoid connecting to the WLAN in situations where the vehicle is likely to leave the coverage area of the WLAN, thus reducing or avoiding instances of rapidly switching to, and then switching away from, a WLAN. As a result, wireless connectivity for the vehicle may be enhanced.

Another advantage may include more rapid connection to a WLAN for the vehicle as compared to other systems. For example, as described above, some systems may utilize a hysteresis condition. Such a hysteresis condition may involve preventing a vehicle from connecting to a WLAN until expiration of a particular time interval. However, in some circumstances, waiting such a time interval may be unnecessary (e.g., if the vehicle is very likely to remain stationary, which may occur, for example, when the vehicle is parked). By intelligently predicting that the vehicle is likely to remain stationary, the vehicle may connect to the WLAN without using hysteresis. As a result, the vehicle may realize benefits associated with the WLAN more rapidly as compared to systems that use hysteresis. Such benefits may include, for example, increased data throughput, increased network stability, and lower latency.

Another advantage may include reduced power consumption and reduced battery usage. To illustrate, some systems may unnecessarily increase power consumption by enforcing a hysteresis condition (which may prevent a vehicle from connecting to a WLAN until expiration of a particular time interval). During this time interval, the vehicle may communicate using a WWAN, which may be associated with greater power consumption as compared to a WLAN. Further, connecting to the WLAN and then leaving the coverage area of the of the WLAN may also unnecessarily increase power consumption for the vehicle. By intelligently using available information related to the vehicle to predict whether the vehicle is likely to remain stationary, a vehicle may avoid use of the hysteresis condition and may also avoid rapidly connecting and disconnecting from a WLAN, thus reducing power consumption and battery usage.

Another advantage may include reduced load on an access point associated with a WLAN. To illustrate, in some scenarios, an access point may be located near a busy intersection and may therefore experience a large quantity of vehicles rapidly connecting to a WLAN of the access point and then disconnecting from the WLAN after leaving a coverage area of the WLAN. As a result, performance of the WLAN may be reduced while offering little benefit for the vehicles connecting to the WLAN. By intelligently using information available to vehicles to predict that the vehicles is likely to leave the coverage area (e.g., using the MSNE process of the first example), the vehicles may avoid connecting to such a WLAN (e.g., when a traffic signal is about to turn green), thus reducing load on the WLAN and improving performance for other users of the WLAN.

Another advantage may include flexible and efficient training of the neural network that may be included in the third stage in connection with the second example. For example, by training the neural network using a variety of data sources (such as locally sourced vehicle data, wireless network condition data, crowd-sourced training data, or a digital twin associated with a vehicle), the neural network may be dynamically trained and may also be updated during vehicle operation in some implementations. Further, by using data already available to a vehicle (such as locally sourced vehicle data), training may be efficient, which may reduce cost and power consumption associated with training the neural network.

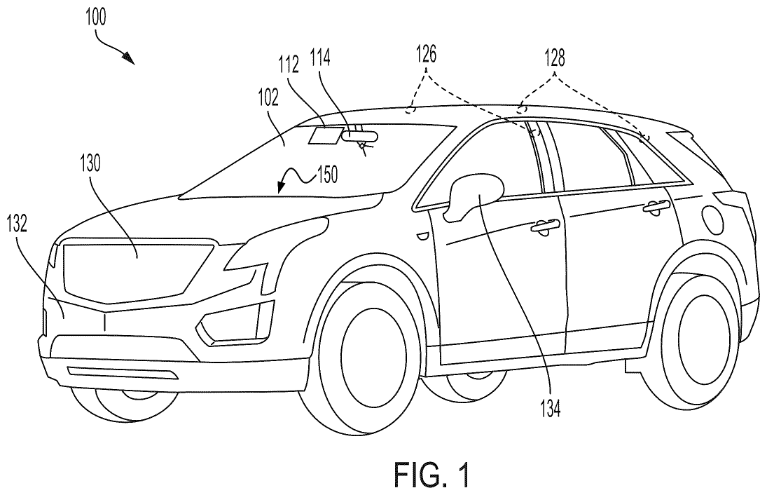

FIG. 1 is a diagram illustrating an example of a vehicle 100 that supports context-aware wireless network selection. The vehicle 100 may make context-aware switch decisions between a WWAN and a WLAN using a variety of information available to the vehicle 100. In some examples, the information may include data that is available to, or processed by, an advanced driver-assistance system (ADAS) 150 of the vehicle 100. The ADAS 150 may include processing devices of the vehicle 100, which may include one or more processors (such as a central processing unit (CPU) and which may be coupled to one or more memories. In some implementations, the ADAS 150 may receive vehicle environmental context data associated with the vehicle 100 (e.g., from one or more sensors of the vehicle 100) and may receive vehicle operation data from one or more subsystems of the vehicle 100, such as an electronic control module (ECM) of the vehicle 100, a communication module of the vehicle 100, a brake pedal position sensor of the vehicle 100, or a cruise control subsystem of the vehicle 100, as illustrative examples. The ADAS 150 may include, or may correspond to, a control system of the vehicle 100, such as an automotive control system of the vehicle 100, a wireless control system of the vehicle 100, or another control system of the vehicle 100. In some examples, at least some components of the ADAS 150 (such as one or more processing devices of the ADAS 150) may be included in a front dashboard area of the vehicle 100. Alternatively, or in addition, at least some components of the ADAS 150 may be located elsewhere in the vehicle 100, such as in a center console of the vehicle 100, in an engine bay of the vehicle 100, or in a trunk or cargo area of the vehicle 100, as illustrative examples. The ADAS 150, or a processor of the ADAS 150, may initiate, control, or perform one or more operations described herein.

In some examples, the ADAS 150 may use information generated by one or more sensors of the vehicle 100 for context-aware switch decisions between a WWAN and a WLAN. One example of such a sensor may be a camera. To illustrate, the vehicle 100 may include a front-facing camera 112 mounted inside the cabin looking through the windshield 102. The vehicle 100 may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

The ADAS 150 may also use other information (alternatively or in addition to image data generated using one or more cameras) for context-aware switch decisions between a WWAN and a WLAN. For example, although some examples may describe cameras, other examples may use other types of sensors, such as a light detection and ranging (LiDAR) sensor that may be included in the vehicle 100, a radio detection and ranging (radar) sensor that may be included in the vehicle 100, one or more other sensors of the vehicle 100, or a combination thereof. Such a set of sensors that includes one or more of a camera, a LiDAR sensor, or a radar sensor may be referred to as a radar-LiDAR-camera (RLC) subsystem of the vehicle 100. The ADAS 150 may use the RLC subsystem to sense an environment of the vehicle 100, such as by sensing a quantity of other vehicles that are proximate to the vehicle 100. A larger quantity of sensed vehicles may indicate that the vehicle 100 is more likely to remain stationary (e.g., in heavy traffic), and a smaller quantity of sensed vehicles may indicate that the vehicle 100 is more likely to be mobile.

Although some examples may be described with reference to an RLC subsystem, the vehicle 100 may include a variety of sensors, such as a parking assist sensor, a gear position sensor, traction control sensors, a brake pedal position sensor, a temperature sensor, a precipitation sensor, one or more other sensors, or a combination thereof. Further, such sensors may be internal to the vehicle 100 or external to the vehicle 100. An internal sensor may detect an operating state of the vehicle 100 or a condition associated with the vehicle 100, and an external sensor may detect a condition that is external to the vehicle 100. Accordingly, sensors of the vehicle 100 may enable a wide range of features, such as object detection, autonomous driving, and safety features. Further, information associated with any such sensor may be used in connection with the disclosure herein (e.g., in connection with predicting whether the vehicle 100 is likely to remain stationary and to perform a context-aware switch decision to select a wireless network of the vehicle 100 in accordance with the prediction).

Further, the ADAS 150 may use other types of information to make context-aware switch decisions alternatively or in addition to using sensor data. In some examples, the vehicle 100 may transmit or receive basic safety messages (BSM), signal phase and timing (SPaT) messages, map and point (MAP) messages, and other types of messages. In some examples, BSM messaging may indicate vehicle information such as position, speed, heading, and brake status, SPAT messaging may indicate traffic light status and timing, and MAP messaging may indicate road geometry and lane information. In some examples, the vehicle 100 may receive such messaging from one or more of a traffic signal controller, a roadside unit (RSU), or a traffic management center. The ADAS 150 may use such messaging for context-aware switch decisions. As an illustrative example, if the BSM, SPaT, and/or MAP messaging indicates a relatively long duration of a red light, and if the ADAS 150 detects a relatively high traffic density (such as based on data received from the RLC subsystem), then the vehicle 100 may be predicted to remain stationarity for a relatively long duration. In such examples, the vehicle 100 may select (or may be more likely to select) a WLAN for communication.

The vehicle 100 may include components or subsystems not illustrated in the example of FIG. 1. To illustrate, the vehicle 100 may include a V2X communication module. The V2X communication mode may include one or more of a dedicated short-range communications (DSRC) transmitter, a DSRC receiver, a DSRC transceiver, a cellular transmitter, a cellular receiver, or a cellular transceiver. In some examples, the V2X communication module may enable the vehicle 100 to transmit and receive messages in accordance with one or more industry standards, such as a Society of Automotive Engineers (SAE) J2735 standard. The vehicle 100 may include an onboard unit (OBU) that includes one or more processors that perform processing associated with one or more operations described herein, such as processing associated with V2X communications. In some implementations, the OBU may be included in an electronic control unit (ECU) of the vehicle 100. Other components or subsystems of the vehicle 100 may include a satellite receiver (such as a global navigation satellite system (GNSS) receiver), an in-vehicle human-machine interface (HMI) module (which may present V2X alerts to an occupant of the vehicle 100), and other types of components or subsystems. Information associated with any such component or subsystem may be used in connection with the disclosure herein. For example, information associated with any such component or subsystem may be used to predict whether the vehicle 100 is likely to remain stationary and to perform a context-aware switch decision to select a wireless network of the vehicle 100 in accordance with the prediction.

Still further, in some examples, the vehicle 100 may include a navigation subsystem. The navigation subsystem may receive navigation information, which may be provisioned by a manufacturer, crowdsourced (e.g., from other vehicles, from one or more servers, or from other sources), downloaded via a firmware update, or obtained in another manner. The navigation information may include, for example, maps, road databases, topographic information, and other data. In some implementations, the navigation information may include or may be dynamically updated with current traffic conditions. Such navigation information may be used in connection with context-aware switch decisions. For example, if the navigation information indicates that the vehicle 100 is stopped in heavy traffic, then the vehicle 100 may be predicted to be likely to remain stationary. Other examples are also within the scope of the disclosure.

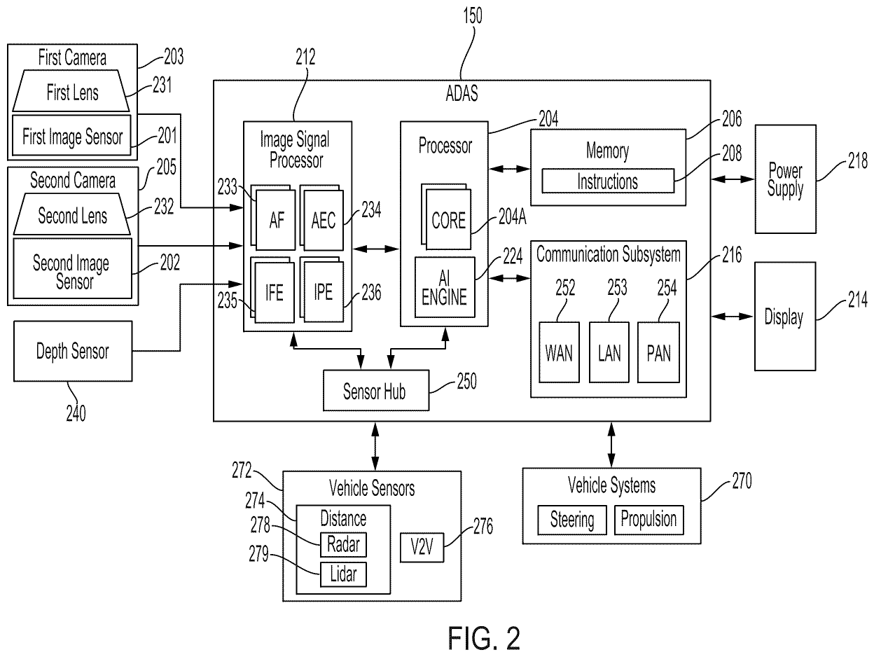

FIG. 2 shows a block diagram of an example configuration of the vehicle 100 of FIG. 1 supporting context-aware wireless network selection. In FIG. 2, the vehicle 100 may include the ADAS 150, which may include, or may be coupled to, various components such as those illustrated in the example of FIG. 2.

In the example of FIG. 2, the vehicle 100 may include, or may be coupled to, an image signal processor 212 for processing image frames from one or more image sensors, such as a first image sensor 201, a second image sensor 202, and a depth sensor 240. The ADAS 150 may be coupled to one or more of the first image sensor 201, the second image sensor 202, or the depth sensor 240. In some implementations, the vehicle 100 also includes or is coupled to a processor 204 (e.g., a CPU) and a memory 206 storing instructions 208. In some examples, the ADAS 150 may include one or more of the processor 204 or the memory 206. The vehicle 100 may also include or be coupled to a display 214 and a communication subsystem 216, each of which may be included in or coupled to the ADAS 150.

The communication subsystem 216 may include network interfaces for communicating with other devices, such as other vehicles, an operator's mobile devices, and/or a remote monitoring system. The network interfaces may include one or more of a wide area network (WAN) interface 252, a local area network (LAN) interface 253, and/or a personal area network (PAN) interface 254. An example WAN interface 252 is a 4G LTE or a 5G NR wireless network interface. An example LAN interface 253 is an IEEE 802.11 WiFi wireless network interface. An example PAN interface 254 is a Bluetooth wireless network interface. Each of the interfaces 252, 253, and/or 254 may include a transceiver and be coupled to one or more antennas, such as antennas configured for primary and diversity reception and/or configured for receiving specific frequency bands.

The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN interface 252 for a wireless communication device. Further, vehicle 100 may include input/output (I/O) components for interacting with a user, such as a touch screen interface and/or physical buttons. In a further example, an analog front end (AFE) to convert analog image frame data to digital image frame data may be coupled between the image sensors 201 and 202 and the image signal processor 212.

The ADAS 150 may include or may be coupled to a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (radar) system, or other ranging systems. For example, the sensor hub 250 may interface to a vehicle bus for sending configuration commands and/or receiving information from vehicle sensors 272, such as distance sensors 274 (e.g., ranging sensors) and vehicle-to-vehicle (V2V) sensors 276 (e.g., sensors for receiving information from nearby vehicles). In some examples, the distance sensors 274 may include one or more of a radar sensor 278 or a LiDAR sensor 279. The vehicle sensors 272 may also include one or more other sensors, such as a throttle position sensor, a brake pedal position sensor, a parking assist sensor, a gear position sensor, traction control sensors, one or more other sensors, or a combination thereof.

The vehicle sensors 272 may enable context-aware selection of a wireless network for the vehicle 100. For example, the vehicle sensors 272 may detect or estimate a quantity of vehicles in the vicinity of the vehicle 100 (e.g., using radar data, LiDAR data, or a combination thereof). A larger quantity of detected or estimated vehicles may indicate that the vehicle 100 is more likely to remain stationary (e.g., in heavy traffic), and a smaller quantity of detected or estimated vehicles may indicate that the vehicle 100 is more likely to be mobile. Alternatively, or in addition, the vehicle sensors 272 may enable object detection, which may be used in connection with context-aware selection of a wireless network for the vehicle 100. For example, if the vehicle 100 is within a garage, the vehicle 100 may be more likely to remain stationary than if the vehicle 100 is located in an open road. Other examples are also within the scope of the disclosure.

For example, one or more operations described herein may be performed using image data captured by one or more cameras. The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

The ADAS 150 may use such imaging in connection with a context-aware switch decision to select a wireless network for wireless communication. For example, the imaging may be used to determine one or more features of an environment of the vehicle 100. The imaging may be analyzed by, for example, a computer vision (CV) application executed by the vehicle 100 to classify the environment of the vehicle 100 (or to identify features of the environment of the vehicle). To illustrate, one example technique may involve recognizing a first set of locations at which the vehicle 100 is likely to remain stationary for at least a threshold time interval (such as a garage or a parking lot), a second set of locations at which the vehicle 100 is not likely to remain stationary for at least a threshold time interval (such as an intersection with a red light duration of less than the threshold time interval), or both. In some examples, the vehicle 100 may connect (or may be more likely to connect) to a WLAN while at the first set of locations and may not connect (or may be less likely to connect) to the WLAN while at the second set of locations.

In some examples, these and other operations for context-aware selection of a wireless network may be performed using one or more processors and a memory that stores instructions executable by the one or more processors. In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the ADAS 150 includes or corresponds to a system on chip (SoC) that incorporates the image signal processor 212, the processor 204, the sensor hub 250, the memory 206, and the communication subsystem 216 into a single package.

In some embodiments, at least one of the image signal processor 212 or the processor 204 executes instructions to perform various operations described herein, including object detection, risk map generation, driver monitoring, and driver alert operations. Each such operation may be associated with data that may be used for context-aware selection of a wireless network. For example, execution of the instructions can instruct the image signal processor 212 to begin or end capturing an image frame or a sequence of image frames. Such an image frame or sequence of image frames may be used to predict whether the vehicle 100 is likely to remain stationary and to select a wireless network in accordance with the prediction. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 214 in the cabin of the vehicle 100.

In some embodiments, the processor 204 may include ICs or other hardware (e.g., an artificial intelligence (AI) engine 224) in addition to the ability to execute software to cause the vehicle 100 or the ADAS 150 to perform a number of functions or operations, such as the operations described herein. In some other embodiments, the vehicle 100 does not include the processor 204, such as when all of the described functionality is configured in the image signal processor 212.

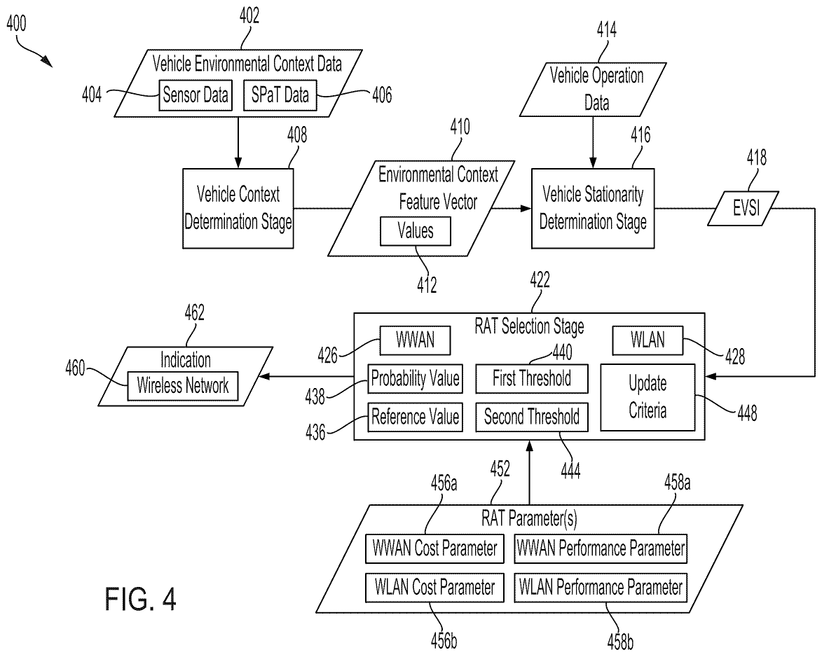

To further illustrate, the ADAS 150 may generate an expected vehicle stationarity index (EVSI) (e.g., using one or more techniques described with reference to FIG. 4) and may input the EVSI to the AI engine 224. The AI engine 224 may may be configured to receive the EVSI and to receive one or more radio access technology (RAT) parameters, such as described further with reference to FIG. 4. The AI engine 224 may be configured to output a WLAN preferability index (WPI) indicating an amount of preference for selecting a WLAN for communication by the vehicle 100. In some examples, the WPI may have a value selected from the range of values from 0 to 1 (where 0≤WPI≤1). Other examples are also within the scope of the disclosure.

The AI engine 224 may be trained using one or more data sets. The one or more data sets may include, for example, one or more of locally sourced vehicle data, wireless network condition data, crowd-sourced training data, or a digital twin associated with the vehicle 100, which may be stored at a cloud server or other device. To illustrate, the AI engine 224 may be trained on wireless network condition data indicating WWAN and WLAN parameters, such as performance parameters and cost parameters.

In some examples, the AI engine 224 may include or may correspond to one or more of a convolutional neural network (CNN), a recurrent neural network (RNN) (such as a long short-term memory (LSTM)), a generative adversarial network (GAN), a multilayer perceptron, a radial basis function network (RBFN), or another type of neural network. Some non-limiting examples are provided for illustration. In some examples, a CNN may perform operations including pattern recognition and traffic flow prediction. For example, the CNN may receive spatial-temporal data and may analyze such data to recognize a pattern in how long the vehicle 100 stays at a particular location (such as a particular stop light) or to predict how long traffic will cause the vehicle 100 to remain at the particular location. The CNN may generate an output indicating a prediction of how long the vehicle 100 is to stay at the particular location.

In some examples, an RNN (such as an LSTM) may receive sequential data (such as time series data) and may analyze such data to predict traffic patterns (e.g., based on historical data). As an example, the RNN may analyze image data to predict whether the vehicle 100 is entering an area associated with heavy or light traffic. In another example, the RNN may receive data indicating settings of an infotainment system of the vehicle 100 and may analyze such data to determine a pattern. One such example of a pattern may indicate that the vehicle 100 is likely to accelerate after the volume of an infotainment system is increased or that the vehicle 100 is likely to decelerate or be placed in park after the volume of the infotainment system is decreased or disabled. The RNN may generate an output indicating an identified pattern or a predicted traffic flow.

A GAN may perform operations such as trajectory prediction or generating diverse and realistic traffic scenarios. Other types of neural networks may include a multilayer perceptron, which may perform operations include traffic prediction and learning from historical data to establish an optimal structure between input and output), and radial basis function networks, which may model the relationships between traffic factors and accident severity. Other examples are also within the scope of the disclosure.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. I/O components of the vehicle 100 may be or include any suitable mechanism, interface, or device to receive input (such as commands) from the user and to provide output to the user through the display 214. For example, the I/O components may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

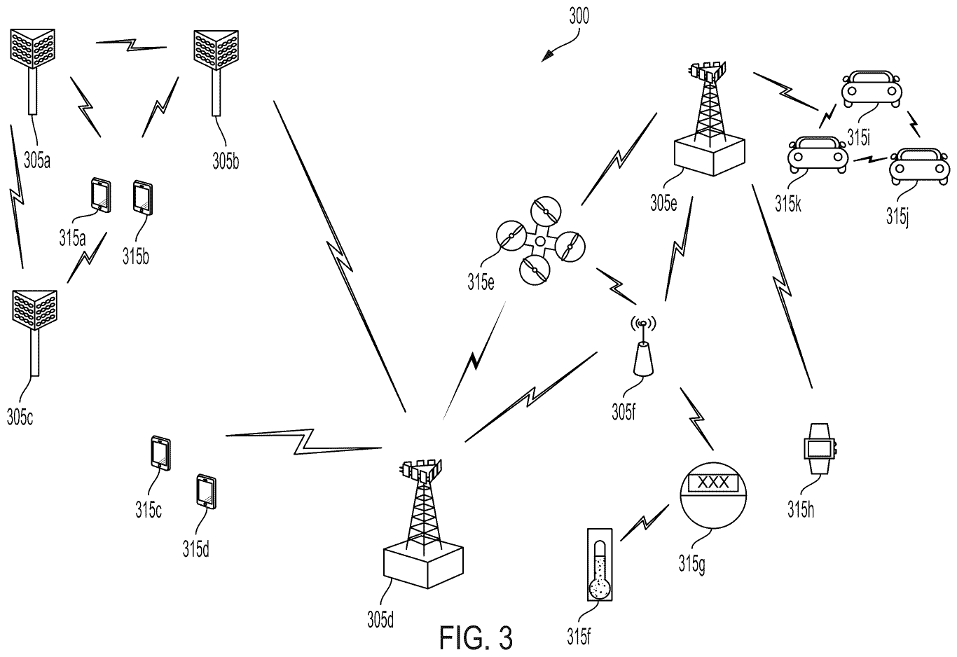

While shown to be coupled to each other via the processor 204, components (such as the processor 204, the memory 206, the image signal processor 212, the display 214, and the I/O components of the vehicle 100) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100. The vehicle 100 may communicate as a user equipment (UE) within a wireless network, such as through WAN interface 252, as shown in FIG. 3.

FIG. 3 is a block diagram illustrating an example wireless network 300 that supports context-aware wireless network selection for a vehicle. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. In the example of FIG. 3, UEs 315a-d may correspond to cellular phones (e.g., smart phones), UEs 315a-k may correspond to vehicles, and UEs 315e, 315f, 315g, and 315h may correspond to a drone, a sensor (e.g., an IoT sensor, such as a thermometer), a smart meter, and a wearable device, respectively. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such as UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e. In some examples, one or more of the UEs 315i-315k may correspond to the vehicle 100 of FIGS. 1 and 2.

One or more features of FIG. 3 may be used in connection with context-aware selection of a wireless network for a vehicle, such as any of the UEs 315i-k. To illustrate, some examples may be described with reference to UE 315i. As UE 315i travels within wireless network 300, UE 315i may connect to base stations 305, which may be included in, or which may be referred to as, a WWAN. Further, UE 315i may in some cases detect availability of a WLAN. The UE 315i may select among the WWAN and the WLAN using one or more techniques described herein. In one example, the UE 315i may identify a rate of handover among the base stations 305 and may use the rate of handover to select among the WWAN and the WLAN. For example, as the rate of handover increases, the UE 315i may be more mobile, and selection of the WWAN (instead of the WLAN) may be more preferred. As another example, as the rate of handover decreases, the UE 315i may be less mobile and selection of the WLAN (instead of the WWAN) may be more preferred. As a particular example, if no handover of the UE 315i has occurred within a threshold time interval, then selection of the WLAN may be preferred over selection of the WWAN.

In addition to communicating with base stations 305 of FIG. 3, in some examples, UE 315i may communicate with one or more other UEs 315. To illustrate, UE 315i may communicate with one or more of the UEs 315a-h and 315j-k using a sidelink communication channel. In some examples, the UE 315i may send and receive V2X messages with one or more of the UEs 315a-h and 315j-k. Such V2X messages may be used to predict whether the UE 315i is likely to remain stationary. For example, if received V2X messaging indicates a traffic jam, the UE 315i may be more likely to remain stationary. As another example, if received V2X messaging indicates sparse traffic, the UE 315i may be less likely to remain stationary.

FIG. 4 is a diagram illustrating an example of a multi-stage system 400 that supports context-aware wireless network selection for a vehicle. In some examples, the multi-stage system 400 may be implemented using a neural network or multiple neural networks. In such examples, each stage of the multi-stage system 400 may correspond to a stage of a neural network. In some examples, the neural network may correspond to the AI engine 224 of FIG. 2. The neural network may include one or more features described with reference to the AI engine 224 of FIG. 2, such as one or more of the CNN, the RNN, the LSTM, the GAN, the multilayer perceptron, the RBFN, or another type of neural network. Other examples are also within the scope of the disclosure.

Further, each stage of the multi-stage system 400 may be implemented in a vehicle, such as the vehicle 100. In some examples, the multi-stage system 400 may be included in, or may be implemented using, the ADAS 150, and at least some operations described with reference to FIG. 4 may be performed by the ADAS 150. Alternatively, or in addition, one or more stages of the multi-stage system 400 may be implemented in a device that is external to the vehicle 100, such as in a server that communicates with the vehicle 100 via one or more communication networks. For example, operations described with reference to FIG. 4 may be shared among the ADAS 150 and a cloud server system, such as in a cooperative processing system, as described further below.

The multi-stage system 400 may include a first stage, such as a vehicle context determination stage 408. The multi-stage system 400 may further include a second stage, such as a vehicle stationarity determination stage 416. The multi-stage system 400 may also include a third stage, such as a radio access technology (RAT) selection stage 422.

The vehicle 100 of FIGS. 1 and 2 may be configured to communicate using multiple wireless communication networks described with reference to FIG. 4. The multiple wireless communication networks may include a first wireless network, such as a wireless wide area network (WWAN) 426, and a second wireless network, such as a wireless local area network (WLAN) 428. In some implementations, the WWAN 426 may include one or more cellular networks, such as one or more of a 4G LTE wireless network, a 5G NR wireless network, or a 6G wireless network. Alternatively, or in addition, the WWAN 426 may include one or more satellite-based communication networks. Further, in some examples, the WLAN 428 may include a wireless network that complies with an Institute of Electrical and Electronics Engineers (IEEE) communication protocol, such as an IEEE 802.11 communication protocol.

During operation, the vehicle 100 may generate vehicle environmental context data 402 associated with the vehicle 100. In some examples, the vehicle environmental context data 402 may include sensor data 404 associated with one or more sensors of the vehicle 100. In some examples, the one or more sensors may include the first camera 203, the second camera 205, the depth sensor 240, any of the vehicle sensors 272, one or more other sensors, or a combination thereof. To further illustrate, the sensor data 404 may include image data, radar data, LiDAR data, or other data indicating whether one or more vehicles are proximate to the vehicle 100, a distance to the one or more vehicles, a speed of the vehicle 100, an acceleration (or deceleration) of the vehicle 100, one or more other features, or a combination thereof.

Alternatively, or in addition, the vehicle environmental context data 402 may include signal phase and timing (SPaT) data 406 associated with a vehicle-to-everything (V2X) protocol. The SPAT data 406 may indicate, for example, a signal phase (such as green, yellow, or red) of a traffic signal proximate to the vehicle 100. Alternatively, or in addition, the SPaT data 406 may indicate timing information related to the traffic signal, such as the duration or estimated duration until the next signal phase of the traffic signal.

The vehicle context determination stage 408 may generate, in accordance with the vehicle environmental context data 402, an environmental context feature vector 410. In some examples, the environmental context feature vector 410 may include values 412 each corresponding to a respective environmental context feature associated with the vehicle. For example, a first bit of the values 412 may indicate whether a traffic signal that is in a field of travel of the vehicle 100 is red (e.g., where a logic zero value indicates that the traffic signal is red, and where a logic one value indicates that the traffic signal is green or yellow). As another example, a second bit of the values 412 may indicate whether the vehicle 100 is accelerating, and a third bit of the values 412 may indicate whether the vehicle 100 is decelerating. Other examples are also within the scope of the disclosure.

The vehicle stationarity determination stage 416 may receive the environmental context feature vector 410 and may also receive vehicle operation data 414 associated with the vehicle 100. In some examples, the vehicle operation data 414 may include one or more of vehicle communication data (such as a V2X communication message received or transmitted by the vehicle 100 in accordance with a V2X protocol), vehicle operation data (such as data indicating a gear position of the vehicle 100, data indicating the status of a turn signal of the vehicle 100, or other data received from a component of the vehicle 100), vehicle positioning data (such as data indicating an estimated position of the vehicle 100 based on one or more of navigation satellite signaling, image data, or other sensor data), or path prediction data associated with the vehicle 100. To further illustrate, in some examples, the vehicle operation data 414 may include data received from one or more subsystems of the vehicle 100, such as an electronic control module (ECM) of the vehicle 100, a communication module of the vehicle 100, a brake pedal position sensor of the vehicle 100, or a cruise control subsystem of the vehicle 100, as illustrative examples.

The vehicle stationarity determination stage 416 may generate, in accordance with the vehicle environmental context feature vector 410 and the vehicle operation data 414, a stationarity index value (EVSI) 418 associated with the vehicle 100. The EVSI 418 may correspond to or indicate a prediction whether the vehicle 100 is to be stationary for at least a threshold time interval to enable selection of a wireless network 460 for communication by the vehicle 100. In some examples, the EVSI 418 may indicate or an amount of confidence, likelihood, or prediction strength that the vehicle 100 is to be stationary for at least the threshold time interval.

To illustrate, in some examples, the EVSI 418 may be selected from a range of values between a first boundary value (e.g., a lower boundary value) and a second boundary value (e.g., an upper boundary value). The first boundary value may indicate that the vehicle 100 is predicted to remain in motion for at least the threshold time interval, such as if the vehicle 100 is traveling on an interstate highway with a relatively large amount of distance until the next exit from the interstate highway. The second boundary value may indicate that the vehicle 100 is predicted to remain stationary for at least the threshold time interval, such as if an ignition of the vehicle 100 is deactivated and a transmission of the vehicle 100 is set to park. In these examples, if the EVSI 418 corresponds to the first boundary value or the second boundary value, the EVSI 418 may indicate a low confidence or a high confidence, respectively, that the vehicle 100 is to be stationary for at least the threshold time interval. A midpoint value between the first boundary value and the second boundary value may correspond to a neutral confidence regarding whether vehicle 100 is to be stationary for at least the threshold time interval.

The RAT selection stage 422 may receive the EVSI 418 and may select the wireless network 460 for communication by the vehicle 100 in accordance with the EVSI 418. In some examples, the RAT selection stage 422 may select among a first wireless network, such as the WWAN 426, and a second wireless network, such as the WLAN 428, in accordance with the EVSI 418. As an illustrative example, if the EVSI 418 indicates that the vehicle 100 is likely to remain in motion, the RAT selection stage 422 may select (or may be more likely to select) the WWAN 426 as the wireless network 460. As another illustrative example, if the EVSI 418 indicates that the vehicle 100 is likely to remain stationary, the RAT selection stage 422 may select (or may be more likely to select) the WLAN 428 as the wireless network 460.

The RAT selection stage 422 may select the wireless network 460 further in accordance with one or more RAT parameters 452. The one or more RAT parameters 452 may be associated with the WWAN 426, the WLAN 428, or both. To illustrate, the one or more RAT parameters 452 may include one or more of a WWAN cost parameter 456a associated with the WWAN 426, a WLAN cost parameter 456b associated with the WLAN 428, a WWAN performance parameter 458a associated with the WWAN 426, or a WLAN performance parameter 458b associated with the WLAN 428. To further illustrate, in some examples, the cost parameters 456a-b may indicate cost in terms of cost per unit of data (e.g., dollars per gigabyte), and the performance parameters 458a-b may indicate performance in terms of data per unit of time (e.g., gigabytes per second). In some examples, the WLAN cost parameter 456b may correspond to (or may be indicated as) zero, such as where connection to the WLAN 428 is a fixed cost instead of a per-data cost.

In some implementations, the RAT selection stage 422 may perform an evaluation of the EVSI 418 and the one or more RAT parameters 452 in accordance with a mixed strategy Nash equilibrium (MSNE) process, such as by evaluating a reselection from one of the WWAN 426 or the WLAN 428 to the other of the WWAN 426 or the WLAN 428 in accordance with the EVSI 418 and the one or more RAT parameters 452. Some such examples are described further below. The RAT selection stage 422 may select one of the WWAN 426 or the WLAN 428 in accordance with the evaluation.

In some implementations, the RAT selection stage 422 may select the wireless network 460 at least in part using a probabilistic technique. For example, the RAT selection stage 422 may determine, in accordance with the EVSI 418 and the one or more RAT parameters 452, a probability value 438 associated with selection of the wireless network 460.

The probability value 438 may be from a range of values from a first value to a second value. For example, the first value may correspond to zero, and the second value may correspond to one. In such examples, the probability value 438 may correspond to zero, one, 0.3, 0.5, 0.9, or another value from the range of values. In some examples, the first value (e.g., zero) may indicate selection of the WWAN 426 as the wireless network 460, the second value (e.g., one) may indicate selection of the WLAN 428 as the wireless network 460, and values between the first value and the second value may be associated with probabilistic selection of either the WWAN 426 or the WLAN 428 as the wireless network 460, as described further below.

To further illustrate, in some examples, the RAT selection stage 422 may determine the probability value 438 in accordance with the example of Equation 1:

$${P}_{WLAN} = f ( EVSI , {R}_{est - WLAN} , {R}_{est - WWAN} , {C}_{WLAN} , {C}_{WWAN} ) . \qquad ( Equation 1 )$$

In Equation 1, P_{WLAN} may indicate the probability value 438, EVSI may indicate the EVSI 418, R_{est-WLAN} may indicate the WLAN performance parameter 458b, R_{est-WWAN} may indicate the WWAN performance parameter 458a, C_{WLAN} may indicate the WLAN cost parameter 456b, and C_{WWAN} may indicate the WWAN cost parameter 456a. Further, ƒ may indicate a function, such as a weighting function that assigns weights to EVSI, R_{est-WLAN}, R_{est-WWAN}, and C_{WWAN}. The function ƒ may be selected based on the particular application (e.g., where different vehicle models may each be associated with a different respective function ƒ).

In some examples, the RAT selection stage 422 may determine the probability value 438 at least in part on a threshold stationarity value, such as a first threshold 440. For example, if the EVSI 418 fails to exceed the first threshold 440 (e.g., where the vehicle 100 is in motion and likely to remain in motion), the probability value 438 may have a particular value associated with selection of (e.g., that causes the vehicle to select) the WWAN 426 as the wireless network 460. In some examples, the particular value may correspond to zero or another low value. In such examples, the probability value 438 may indicate a zero percent probability (or another low probability) of selecting the WLAN 428 as the wireless network 460. For example, if the vehicle 100 is traveling on an interstate highway with a relatively large amount of distance until the next exit from the interstate highway, the probability value 438 may correspond to zero (or another low value). In other cases, the probability value 438 may have another value, such as if an ignition of the vehicle is deactivated and a transmission of the vehicle is set to park.

In some other examples, the EVSI 418 may exceed the first threshold 440. In accordance with the EVSI 418 exceeding the first threshold 440, the RAT selection stage 422 may compare the probability value 438 to a reference value 436 to select the wireless network 460. In some examples, the reference value 436 may be randomly or pseudo-randomly generated. For example, the RAT selection stage 422 may include or may execute a pseudorandom number generator (PRNG) that randomly or pseudo-randomly selects from among a range of values (e.g., a range of values between 0 and 1) as the reference value 436. Use of such a probabilistic technique may reduce or avoid some undesirable scenarios, such as if a large group of vehicles each connect to the same WLAN, which may reduce performance associated with the WLAN. Further, use of a probabilistic technique may enable an equilibrium condition, as described further below.

In some examples, the probability value 438 may exceed the reference value 436, and the RAT selection stage 422 may select the WWAN 426 as the wireless network 460. In some other examples, the probability value 438 fail to exceed the reference value 436, and the RAT selection stage 422 may select the WLAN 428 as the wireless network 460. To illustrate, Inequality 1 illustrates an example of a switch decision that may select either the WWAN 426 or the WLAN 428 as the wireless network 460:

If rand(0 1) ≤ P_{WLAN}, then select WLAN 428; else, select WWAN 426 (Inequality 1).

In Inequality 1, rand (0 1) may correspond to the reference value 436, and P WLAN may correspond to the probability value 438.

In some contexts, operation of the RAT selection stage 422 as described above (e.g., using Equation 1 and Inequality 1) may involve, or may be referred to as, a mixed strategy process or a mixed strategy Nash equilibrium (MSNE) process. For example, if multiple vehicles probabilistically select among the WWAN 426 and the WLAN 428 (e.g., using the probability value 438), then the multiple vehicles may be referred to as “players” in the MSNE process. The MSNE process may enable an equilibrium condition (or a range of equilibrium-like conditions). For example, as more vehicles connect to the WLAN 428, performance of the WLAN 428 may decrease, which may decrease R_{est-WLAN} in Equation 1. In this example, the probability value 438 may decrease, which may decrease the probability of connecting to the WLAN 428 (since connecting to the WLAN 428 may be less advantageous due to decreased performance of the WLAN 428). Similarly, as fewer vehicles connect to the WLAN 428, performance of the WLAN 428 may increase, which may increase R_{est-WLAN} in Equation 1 (and which may increase the probability of connecting to the WLAN 428). Similar effects may occur at the WWAN 426 (e.g., where fewer connections increase performance, and where more connections decrease performance). As a result, an equilibrium condition (or a range of equilibrium-like conditions) may be achieved in which the vehicle 100 does not “prefer” the WWAN 426 to the WLAN 428 (or vice versa).

Alternatively, or in addition, the RAT selection stage 422 may use a neural network to select the wireless network 460. In some examples, the neural network may correspond to the AI engine 224 of FIG. 2. The neural network may include one or more features described with reference to the AI engine 224 of FIG. 2, such as one or more of the CNN, the RNN, the LSTM, the GAN, the multilayer perceptron, the RBFN, or another type of neural network. In such examples, selecting the wireless network 460 may include inputting the EVSI 418 and the one or more RAT parameters 452 to the neural network. Selecting the wireless network 460 may further include receiving, in accordance with the EVSI 418 and the one or more RAT parameters 452, an output of the neural network indicating the wireless network 460. The RAT selection stage 422 may select the wireless network 460 in accordance with the output. In some examples, the neural network may include a machine learning (ML) model trained on one or more features described herein, such as the EVSI 418 and the one or more RAT parameters 452.

During a training mode, the neural network may receive training data as an input. The training data may include a training set of values for at least some features described with reference to the RAT selection stage 422. For example, the training data may include a training set of values of the EVSI 418 and a training set of values of the one or more RAT parameters 452. Depending on the example, the training data may include one or more of locally sourced vehicle data, wireless network condition data, crowd-sourced training data, or a digital twin associated with the vehicle 100, which may be stored at a cloud server or other device.

To further illustrate, in some examples, at least some values of the training data may be labeled. For example, smaller values of the EVSI 418 may be labeled as being associated with lower values of the probability value 438 (and more likely selection of the WWAN 426), particularly when accompanied in the training data by one or more of a small value of the WWAN cost parameter 456a, a large value of the WLAN cost parameter 456b, a large value of the WWAN performance parameter 458a, or a small value of the WLAN performance parameter 458b. As another example, larger values of the EVSI 418 may be labeled as being associated with greater values of the probability value 438 (and with more likely selection of the WLAN 428), particularly when accompanied in the training data by one or more of a large value of the WWAN cost parameter 456a, a small value of the WLAN cost parameter 456b, a small value of the WWAN performance parameter 458a, or a large value of the WLAN performance parameter 458b. An output of the neural network may be generated based on the training data and may be evaluated. In some implementations, parameters associated with the neural network may be updated based on the output (e.g., by adjusting weights associated with the neural network using a backpropagation technique). Other examples are also within the scope of the disclosure. For example, in other implementations, unlabeled training data may be used, such as where the neural network is trained using locally sourced data associated with the vehicle 100, a digital twin of the vehicle 100, crowdsourced data from one or more other vehicles, training data from one or more other sources (such as a cloud server), or a combination thereof.

After completion of the training mode, the neural network may operate according to an inference mode of operation. During the inference mode of the neural network, the ADAS 150 may dynamically determine values of the EVSI 418 and the one or more RAT parameters. The ADAS 150 may input the EVSI 418 and the one or more RAT parameters to the neural network, and the neural network may use learned characteristics to select the wireless network 460 in accordance with the EVSI 418 and the RAT parameters 452. For example, the neural network may apply the parameters learned during the training mode to select either the WWAN 426 or the WLAN 428 in accordance with the EVSI 418 and the RAT parameters 452. Upon applying the parameters, the neural network may output the indication 462 of the wireless network 460. In some examples, the indication 462 may include or may be referred to as a WLAN preferability index (WPI). In some examples, the ADAS 150 may select the WLAN 428 for communication if a randomly selected value is less than or equal to the WPI and may select the WWAN 426 if the WPI exceeds the WPI.

To further illustrate, the ADAS 150 may avoid selecting the WLAN 428 in situations in which the vehicle 100 is predicted to begin moving relatively soon, such as if the vehicle 100 is temporarily stopped at a stop sign. In such examples, the vehicle 100 may remain connected to the WWAN 426 and may avoid a handover to the WLAN 428. In some other examples, the vehicle 100 may be predicted to remain stationary for a relatively long duration, such as if the SPaT data 406 indicates a relatively long duration of the red light, and if the ADAS 150 detects a relatively high traffic density (such as based on image data, LiDAR data, radar data, or received V2V messages). In such examples, the vehicle 100 may be predicted to remain stationarity for a relatively long duration. In such examples, the ADAS 150 may select (or may be more likely to select) the WLAN 428.

In accordance with selection of the wireless network 460, the RAT selection stage 422 may output an indication 462 of the wireless network 460. In some examples, the indication 462 may have a first value indicating the WWAN 426 (e.g., in accordance with the probability value 438 exceeding the reference value 436, or in accordance with the output of the neural network indicating the WWAN 426). In some other examples, the indication 462 may have a second value indicating the WLAN 428 (e.g., in accordance with the probability value 438 failing to exceed the reference value 436, or in accordance with the output of the neural network indicating the WLAN 428). In some examples, the multi-stage system 400 may provide the indication 462 to the communication subsystem 216 of FIG. 2.

Accordingly, the RAT selection stage 422 may be implemented using a variety of techniques, such as, for example, using the MSNE process or using the neural network that are described above. Further, the implementation of the RAT selection stage 422 may be determined based on the particular application. For example, some scenarios may involve a relatively low availability of training data, or the vehicle 100 may be relatively sensitive to power consumption (e.g., in some electric vehicle (EV) implementations of the vehicle 100). In some such examples, the RAT selection stage 422 may be implemented using the MSNE process to reduce or avoid training and power consumption that may be associated with the neural network.

The communication subsystem 216 may select among wireless communication interfaces in accordance with the indication 462. In some examples, in accordance with the indication 462 specifying the WWAN 426 as the wireless network 460, the communication subsystem 216 may activate the WAN interface 252. Further, the communication subsystem 216 may optionally wake the WAN interface 252 from a sleep mode, may initiate a sleep mode of the LAN interface 253, or both. In some other examples, in accordance with the indication 462 specifying the WLAN 428 as the wireless network 460, the communication subsystem 216 may activate the LAN interface 253. Further, the communication subsystem 216 may optionally wake the LAN interface 253 from a sleep mode, may initiate a sleep mode of the WAN interface 252, or both. To further illustrate, in some examples, the communication subsystem 216 may perform, in accordance with the indication 462 specifying a change in the wireless network 460, a handoff from one of the WWAN 426 or the WLAN 428 to the other of the WWAN 426 or the WLAN 428.

After selecting the wireless network 460, the vehicle 100 may perform one or more communication operations using the wireless network 460. For example, if the wireless network 460 corresponds to the WWAN 426, the vehicle 100 may use the WAN interface 252 of FIG. 2 to send a wireless communication message, to receive a wireless communication message, or both. As another example, if the wireless network 460 corresponds to the WLAN 428, the vehicle 100 may use the LAN interface 253 of FIG. 2 to send a wireless communication message, to receive a wireless communication message, or both.

To further illustrate, in some examples, communicating using the wireless network 460 may include transmitting a V2X message, receiving a V2X message, or both. Examples of V2X messages may include vehicle-to-vehicle (V2V) messages, vehicle-to-infrastructure (V2I) messages, vehicle-to-network (V2N) messages, and vehicle-to-pedestrian (V2P) messages, as illustrative examples. Further, in some examples, the vehicle 100 may use the wireless network 460 as a primary network that enables an auxiliary network of the vehicle 100, such as a data hotspot. In such examples, one or more UEs may wirelessly connect to the data hotspot, which may receive data connectivity through the wireless network 460. In some examples, the one or more UEs may include a mobile phone (such as UEs 315a-d of FIG. 3, a wearable device (such as UE 315h of FIG. 3), one or more other devices, or a combination thereof.

In some examples, the multi-stage system 400 may initiate selection (and reselection) of the wireless network 460 in accordance with detecting that one or more update criteria 448 associated with selection of the wireless network 460 are satisfied. Detection of the one or more update criteria 448 (and other operations) may be performed by the ADAS 150, by a device external to the vehicle (such as a cloud server), or a combination thereof. To illustrate, in one example, the cloud server may provide an indication to the ADAS 150 that prompts the ADAS to trigger reselection of the wireless network 460. In some examples, the one or more update criteria 448 may include expiration of a time interval. For example, the time interval may correspond to a time interval x, and the multi-stage system 400 may initiate selection of the wireless network 460 every x seconds. In some such examples, the cloud server may trigger reselection of the wireless network 460 every x seconds.

Alternatively, or in addition, the one or more update criteria 448 may include a change in the EVSI 418, such as a change in the EVSI 418 that exceeds a second threshold 444. Such a change may indicate a sudden change in expected mobility of the vehicle 100. In some examples, values of the EVSI 418 may be monitored by the cloud server, and the cloud server may provide an indication to the ADAS 150 if the EVSI 418 exceeds the second threshold 444.

Alternatively, or in addition, the one or more update criteria 448 may include a change in at least one of the one or more RAT parameters 452. For example, such a change in at least one of the one or more RAT parameters 452 may indicate a change in wireless communication quality of one or more of the WWAN 426 or the WLAN 428. In some examples, such a change may increase probability that the WWAN 426 is selected as the wireless network 460 (such as if communication quality of the WWAN 426 has increased, if performance of the WLAN 428 has decreased, or both). In some other examples, such a change may increase probability that the WLAN 428 is selected as the wireless network 460 (such as if communication quality of the WWAN 426 has decreased, if performance of the WLAN 428 has increased, or both). In some examples, the cloud server may monitor changes in at least some of the one or more RAT parameters 452, such as by receiving crowdsourced information indicating network conditions or communication quality associated with one or more of the WWAN 426 or the WLAN 428. In such examples, the cloud server may indicate such a change to the ADAS 150 to trigger the ADAS 150 to perform reselection of the wireless network 460.

To further illustrate, after selecting the wireless network 460, the vehicle may determine that the one or more update criteria 448 are satisfied. In accordance with detecting that the one or more update criteria are satisfied, the ADAS 150 may receive an updated version of the vehicle environmental context data 402 and an updated version of the vehicle operation data 414. The vehicle 100 may generate an updated version of the EVSI 418 in accordance with the updated version of the vehicle environmental context data 402 (e.g., after generating an updated version of the environmental context feature vector 410) and the updated version of the vehicle operation data 414. The ADAS 150 may perform, in accordance with the updated version of the EVSI 418, a switch decision to determine whether to switch from one of the WWAN 426 or the WLAN 428 to the other of the WWAN 426 or the WLAN 428.

Such switch decisions and other operations described with reference to the multi-stage system 400 may be performed using one or more components of a vehicle (such as the ADAS 150 of the vehicle 100), using a device external to the vehicle 100 (such as a cloud server), or a combination thereof. To illustrate, each stage of the multi-stage system 400 may be implemented using one or more components of a vehicle (such as the ADAS 150), using a device external to the vehicle 100 (such as the cloud server), or a combination thereof. In some examples, operations described with reference to FIG. 4 may be shared among the ADAS 150 and a cloud server system in a cooperative processing system. In the cooperative processing system, at least some operations (such as computationally intense operations) may be “offloaded” from the ADAS 150 to the cloud server system to reduce usage of processing resources of the ADAS 150, to reduce power consumption of the vehicle 100, or both.

To illustrate, in some examples of the cooperative processing system, the ADAS 150 may collect or generate data of the vehicle 100 (such as the vehicle environmental context data 402 and the vehicle operation data 414) and may provide (e.g., via the WWAN 426) the data to the cloud server system. The data may optionally include the one or more RAT parameters 452, or the cloud server system may receive the one or more RAT parameters 452 from another source (such as from one or more network providers). The cloud server system may receive the data and may use the data to generate one or more of the environmental context feature vector 410, the EVSI 418, or the indication 462 of the wireless network 460. Further, in some implementations, the cloud server system may provide (e.g., via the WWAN 426) one or more of the environmental context feature vector 410, the EVSI 418, or the indication 462 of the wireless network 460 to the vehicle 100. To further illustrate, the cloud server system may provide to the vehicle 100 a direct indication of the wireless network 460 or information usable by the ADAS 150 to select the wireless network 460. Such information may include one or more of the environmental context feature vector 410, the EVSI 418, or other information.

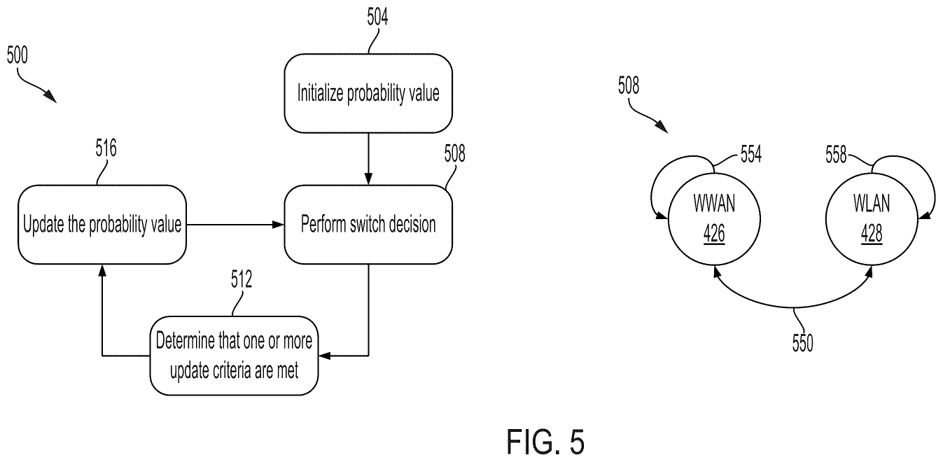

Further, in some examples of the cooperative processing system, the ADAS 150 may share at least some processing operations with the cloud server system. Some such examples may involve distributing or “sharing” computationally intensive operations among the ADAS 150 and the cloud server system. To illustrate, in some examples, the ADAS 150 may parse or pre-process data including at least some of the vehicle environmental context data 402, the environmental context feature vector 410, the vehicle operation data 414, the EVSI 418, or the one or more RAT parameters 452. For example, the ADAS 150 may pre-process at least some of the data by converting a data format associated with the data or otherwise encoding the data, compressing the data, encrypting the data, or performing other operations, prior to sending the data to the cloud server system. Alternatively, or in addition, the ADAS 150 may identify more relevant data and may provide such data to the cloud server system (e.g., while excluding less relevant data). As an illustrative example, more relevant data may include data indicating that a gear selector of the vehicle 100 indicates the vehicle is parked or in drive, and less relevant data may include data indicating that an acceleration of the vehicle 100 is zero (which may occur either when the vehicle 100 is parked or in drive). By providing more relevant data to the cloud server system (and excluding less relevant data), switch decisions may occur more rapidly, and power consumption and usage of wireless resources may be reduced. Some further examples that may be associated with switch decisions are described further with reference to FIG. 5.

FIG. 5 is a diagram illustrating examples of operations 500 that support context-aware wireless network selection for a vehicle. In some examples, one or more of the operations 500 may be performed by the ADAS 150. Alternatively, or in addition, one or more of the operations 500 may be performed by a device that is external to the vehicle 100, such as a server that communicates with the vehicle 100 via one or more communication networks. As an example, one or more of the operations 500 may be performed by the cloud server system described above. Such a cloud server system may perform processing separately from the ADAS 150 or may share at least some processing with the ADAS 150, such as in the case of a cooperative processing system. In such examples, each of the operations 500 may be performed individually or collectively by the ADAS 150 and the cloud server system.

The operations 500 may include initializing a probability value, at 504. The probability value may correspond to the probability value 438 of FIG. 4. In some examples, the probability value may correspond to P_{WLAN} and may be determined in accordance with Equation 1 (above).

The operations 500 may further include performing a switch decision, at 508. For example, the wireless network 460 may be selected from among the WWAN 426 and the WLAN 428 using one or more techniques or operations described herein. In some examples, the switch decision may be performed in accordance with Inequality 1 (above).

To further illustrate, in some examples, performing the switch decision (at 508) may include reselecting, at 550, from one of the WWAN 426 and the WLAN 428 to the other of the WWAN 426 and the WLAN 428 as the wireless network 460. In some other examples, performing the switch decision may include maintaining, at 554, the WWAN 426 as the wireless network 460. In some further examples, performing the switch decision may include maintaining, at 558, the WLAN 428 as the wireless network 460.

The operations 500 may further include determining that one or more update criteria are met, at 512. For example, the one or more update criteria 448 may be satisfied in accordance with one or more examples described with reference to FIG. 4.

The operations 500 may further include updating the probability value, at 516. For example, the probability value 438 may be updated in accordance with updated versions of any of the vehicle environmental context data 402, the environmental context feature vector 410, the vehicle operation data 414, the EVSI 418, and the one or more RAT parameters 452. After updating the probability value (at 516), the operations 500 may continue, at 508.

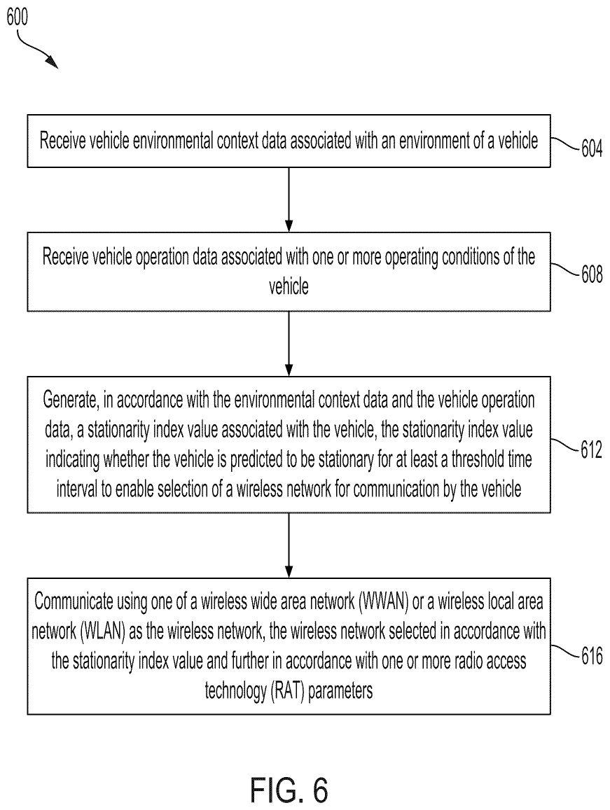

FIG. 6 is a flow chart illustrating an example method 600 that supports context-aware wireless network selection for a vehicle. In some examples, the method 600 may be performed to select the wireless network 460 of the vehicle 100. Further, one or more operations of the method 600 may be performed by the ADAS 150. Alternatively, or in addition, one or more operations of the method 600 may be performed by a device that is external to the vehicle 100, such as a server that communicates with the vehicle 100 via one or more communication networks. As an example, one or more operations of the method 600 may be performed by the cloud server system described above. Such a cloud server system may perform processing separately from the ADAS 150 or may share at least some processing with the ADAS 150, such as in the case of a cooperative processing system. In such examples, each operation of the method 600 may be performed individually or collectively by the ADAS 150 and the cloud server system.

The method 600 includes receiving vehicle environmental context data associated with an environment of the vehicle, at 604. In some examples, the vehicle environmental context data may correspond to the vehicle environmental context data 402.

The method 600 further includes receiving vehicle operation data associated with one or more operating conditions of the vehicle, at 608. In some examples, the vehicle operation data may correspond to the vehicle operation data 414.

The method 600 further includes generating, in accordance with the vehicle environmental context data and the vehicle operation data, a stationarity index value associated with the vehicle, at 612. The stationarity index value indicates whether the vehicle is predicted to be stationary for at least a threshold time interval to enable selection of a wireless network for communication by the vehicle. In some examples, the stationarity index value may correspond to the EVSI 418.

The method 600 further includes communicating using one of a wireless wide area network (WWAN) or a wireless local area network (WLAN) as the wireless network, at 616. The wireless network is selected in accordance with the stationarity index value and further in accordance with one or more radio access technology (RAT) parameters. In some examples, the WWAN may correspond to the WWAN 426, the WLAN may correspond to the WLAN 428, and the one or more RAT parameters may correspond to the one or more RAT parameters 452.

In some implementations, a processing system may be configured to perform one or more operations described herein, such as one or more operations of the method 600. The processing system may include one or more processors and one or more memories coupled to the one or more processors. In some examples, the one or more processors may include the processor 204, and the one or more memories may include the memory 206. In some implementations, the processing system may be included in a component of a vehicle (such as the ADAS 150) or in a cloud server system. Alternatively, or in addition, a computer-readable medium (such as the memory 206) may store instructions (such as the instructions 208) executable by one or more processors (such as the processor 204) to initiate, perform, or control one or more operations described herein, such as one or more operations of the method 600. In some implementations, the computer-readable medium may be included in a component of a vehicle (such as the ADAS 150) or in a cloud server system.

In a first aspect, an apparatus for wireless network selection for a vehicle includes a processing system including one or more processors and one or more memories coupled to the one or more processors. The processing system is configured to receive vehicle environmental context data associated with an environment of the vehicle and to receive vehicle operation data associated with one or more operating conditions of the vehicle. The processing system is further configured to generate, in accordance with the vehicle environmental context data and the vehicle operation data, a stationarity index value associated with the vehicle. The stationarity index value indicates whether the vehicle is predicted to be stationary for at least a threshold time interval to enable selection of a wireless network for communication by the vehicle. The processing system is further configured to initiate communication using one of a wireless wide area network (WWAN) or a wireless local area network (WLAN) as the wireless network. The wireless network selected in accordance with the stationarity index value and further in accordance with one or more radio access technology (RAT) parameters.

In a second aspect, in combination with the first aspect, the processing system is further configured to select the stationarity index value from a range of values between a first boundary value and an second boundary value, the first boundary value indicating that the vehicle is predicted to remain in motion for at least the threshold time interval, and the second boundary value indicating that the vehicle is predicted to remain stationary for at least the threshold time interval.

In a third aspect, in combination with one or more of the first aspect or the second aspect, the processing system is further configured to determine, in accordance with the stationarity index value and the one or more RAT parameters, a probability value associated with selection of the wireless network, the probability value from a range of values from a first value to a second value, the first value indicating selection of the WWAN as the wireless network, the second value indicating selection of the WLAN as the wireless network, and values between the first value and the second value associated with probabilistic selection of either the WWAN or the WLAN as the wireless network.

In a fourth aspect, in combination with one or more of the first aspect through the third aspect, in accordance with the stationarity index value failing to exceed a threshold stationarity value, the probability value has a particular value associated with selection of the WWAN as the wireless network.

In a fifth aspect, in combination with one or more of the first aspect through the fourth aspect, in accordance with the stationarity index value exceeding the threshold stationarity value, the processing system is further configured to compare the probability value to a reference value and to output an indication of the wireless network to a communication subsystem of the vehicle, the indication having one of a first value indicating the WWAN in accordance with the probability value exceeding the reference value or a second value indicating the WLAN in accordance with the probability value failing to exceed the reference value.

In a sixth aspect, in combination with one or more of the first aspect through the fifth aspect, the one or more RAT parameters include one or more of a WWAN cost parameter indicating cost associated with the WWAN in terms of cost per unit of data, a WLAN cost parameter indicating cost associated with the WLAN in terms of cost per unit of data, a WWAN performance parameter indicating performance associated with the WWAN in terms of data per unit of time, or a WLAN performance parameter indicating performance associated with the WLAN in terms of data per unit of time.

In a seventh aspect, in combination with one or more of the first aspect through the sixth aspect, the vehicle operation data includes one or more of vehicle communication data, vehicle operation data, vehicle positioning data, or path prediction data associated with the vehicle.

In an eighth aspect, in combination with one or more of the first aspect through the seventh aspect, the processing system is further configured to detect that one or more update criteria associated with selection of the wireless network are satisfied, the one or more update criteria including one or more of expiration of a time interval, a change in the stationarity index value satisfying a threshold stationarity value, or a change in the one or more RAT parameters indicating a change in wireless communication quality of one or more of the WWAN or the WLAN.

In a ninth aspect, in combination with one or more of the first aspect through the eighth aspect, in accordance with detecting that the one or more update criteria are satisfied, the processing system is further configured to receive an updated version of the vehicle environmental context data, to receive an updated version of the vehicle operation data, to generate an updated version of the stationarity index value in accordance with the updated version of the vehicle environmental context data and the updated version of the vehicle operation data, and to perform, in accordance with the updated version of the stationarity index value, a switch decision to determine whether to switch from one of the WWAN or the WLAN to the other of the WWAN or the WLAN.

In a tenth aspect, in combination with one or more of the first aspect through the ninth aspect, the processing system is further configured to input the stationarity index value and the one or more RAT parameters to a neural network, and to receive, in accordance with the stationarity index value and the one or more RAT parameters, an output of the neural network indicating the wireless network, the wireless network selected further in accordance with the output.

In an eleventh aspect, in combination with one or more of the first aspect through the tenth aspect, the vehicle environmental context data includes signal phase and timing (SPaT) data and further includes sensor data associated with one or more sensors of the vehicle, the one or more sensors including at least one of a radar sensor of the vehicle, a light detection and ranging (LiDAR) sensor of the vehicle, or a camera of the vehicle.

In a twelfth aspect, in combination with one or more of the first aspect through the eleventh aspect, the processing system is further configured to generate, in accordance with the vehicle environmental context data, an environmental context feature vector that includes a plurality of values each corresponding to a respective environmental context feature associated with the vehicle, the stationarity index value further in accordance with the environmental context feature vector.

In a thirteenth aspect, a method of wireless network selection for a vehicle includes receiving vehicle environmental context data associated with an environment of the vehicle and receiving vehicle operation data associated with one or more operating conditions of the vehicle. The method further includes generating, in accordance with the vehicle environmental context data and the vehicle operation data, a stationarity index value associated with the vehicle. The stationarity index value indicates whether the vehicle is predicted to be stationary for at least a threshold time interval to enable selection of a wireless network for communication by the vehicle. The method further includes communicating using one of a wireless wide area network (WWAN) or a wireless local area network (WLAN) as the wireless network. The wireless network is selected in accordance with the stationarity index value and further in accordance with one or more radio access technology (RAT) parameters.

In a fourteenth aspect, in combination with the thirteenth aspect, the stationarity index value is selected from a range of values between a first boundary value and an second boundary value, the first boundary value indicating that the vehicle is predicted to remain in motion for at least the threshold time interval, and the second boundary value indicating that the vehicle is predicted to remain stationary for at least the threshold time interval.

In a fifteenth aspect, in combination with one or more of the thirteenth aspect through the fourteenth aspect, the method further includes determining, in accordance with the stationarity index value and the one or more RAT parameters, a probability value associated with selection of the wireless network, the probability value from a range of values from a first value to a second value, the first value indicating selection of the WWAN as the wireless network, the second value indicating selection of the WLAN as the wireless network, and values between the first value and the second value associated with probabilistic selection of either the WWAN or the WLAN as the wireless network.

In a sixteenth aspect, in combination with one or more of the thirteenth aspect through the fifteenth aspect, in accordance with the stationarity index value failing to exceed a threshold stationarity value, the probability value has a particular value that causes the vehicle to select the WWAN as the wireless network.

In a seventeenth aspect, in combination with one or more of the thirteenth aspect through the sixteenth aspect, the method further includes, in accordance with the stationarity index value exceeding the threshold stationarity value, comparing the probability value to a reference value and outputting an indication of the wireless network to a communication subsystem of the vehicle, the indication having one of a first value indicating the WWAN in accordance with the probability value exceeding the reference value or a second value indicating the WLAN in accordance with the probability value failing to exceed the reference value.

In an eighteenth aspect, a non-transitory computer-readable medium stores instructions executable by one or more processors to initiate, perform, or control operations for wireless network selection for a vehicle. The operations include receiving vehicle environmental context data associated with an environment of the vehicle and receiving vehicle operation data associated with one or more operating conditions of the vehicle. The operations further include generating, in accordance with the vehicle environmental context data and the vehicle operation data, a stationarity index value associated with the vehicle. The stationarity index value indicates whether the vehicle is predicted to be stationary for at least a threshold time interval to enable selection of a wireless network for communication by the vehicle. The operations further include communicating using one of a wireless wide area network (WWAN) or a wireless local area network (WLAN) as the wireless network. The wireless network is selected in accordance with the stationarity index value and further in accordance with one or more radio access technology (RAT) parameters.

In a nineteenth aspect, in combination with the eighteenth aspect, the operations further comprise detecting that one or more update criteria associated with selection of the wireless network are satisfied, the one or more update criteria including one or more of expiration of a time interval, a change in the stationarity index value satisfying a threshold stationarity value, or a change in the one or more RAT parameters indicating a change in wireless communication quality of one or more of the WWAN or the WLAN.

In a twentieth aspect, in combination with one or more of the eighteenth aspect through the nineteenth aspect, the operations further include, in accordance with detecting that the one or more update criteria are satisfied, receiving an updated version of the vehicle environmental context data, receiving an updated version of the vehicle operation data, generating an updated version of the stationarity index value in accordance with the updated version of the vehicle environmental context data and the updated version of the vehicle operation data, and performing, in accordance with the updated version of the stationarity index value, a switch decision to determine whether to switch from one of the WWAN or the WLAN to the other of the WWAN or the WLAN.

In the figures, a single block may be described as performing a function or functions: The function or functions performed by that block may be performed in a single component or across multiple components, and/or may be performed using hardware, software, or a combination of hardware and software. To illustrate, various illustrative components, blocks, modules, circuits, and operations may be described in terms of functionality. Whether such functionality is implemented as hardware or software may depend upon the particular application and the overall system design. Skilled artisans may implement the described functionality in varying ways for each particular application, but such implementation decisions should not be interpreted as causing a departure from the scope of the disclosure. Also, the example devices may include components other than those shown, including components such as a processor, memory, and the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (such as application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or process disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 5, 5, or 50 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless network selection for a vehicle, the apparatus comprising:
a processing system including one or more processors and one or more memories coupled to the one or more processors, the processing system configured to:
receive vehicle environmental context data associated with an environment of the vehicle;
receive vehicle operation data associated with one or more operating conditions of the vehicle;
generate, in accordance with the vehicle environmental context data and the vehicle operation data, a stationarity index value associated with the vehicle, the stationarity index value indicating whether the vehicle is predicted to be stationary for at least a threshold time interval to enable selection of a wireless network for communication by the vehicle; and
initiate communication using one of a wireless wide area network (WWAN) or a wireless local area network (WLAN) as the wireless network, the wireless network selected in accordance with the stationarity index value and further in accordance with one or more radio access technology (RAT) parameters.

2. The apparatus of claim 1, wherein the processing system is further configured to select the stationarity index value from a range of values between a first boundary value and an second boundary value, the first boundary value indicating that the vehicle is predicted to remain in motion for at least the threshold time interval, and the second boundary value indicating that the vehicle is predicted to remain stationary for at least the threshold time interval.

3. The apparatus of claim 1, wherein the processing system is further configured to determine, in accordance with the stationarity index value and the one or more RAT parameters, a probability value associated with selection of the wireless network, the probability value from a range of values from a first value to a second value, the first value indicating selection of the WWAN as the wireless network, the second value indicating selection of the WLAN as the wireless network, and values between the first value and the second value associated with probabilistic selection of either the WWAN or the WLAN as the wireless network.

4. The apparatus of claim 3, wherein, in accordance with the stationarity index value failing to exceed a threshold stationarity value, the probability value has a particular value associated with selection of the WWAN as the wireless network.

5. The apparatus of claim 4, wherein in accordance with the stationarity index value exceeding the threshold stationarity value, the processing system is further configured to:
compare the probability value to a reference value; and
output an indication of the wireless network to a communication subsystem of the vehicle, the indication having one of a first value indicating the WWAN in accordance with the probability value exceeding the reference value or a second value indicating the WLAN in accordance with the probability value failing to exceed the reference value.

6. The apparatus of claim 1, wherein the one or more RAT parameters include one or more of:
a WWAN cost parameter indicating cost associated with the WWAN in terms of cost per unit of data;
a WLAN cost parameter indicating cost associated with the WLAN in terms of cost per unit of data;
a WWAN performance parameter indicating performance associated with the WWAN in terms of data per unit of time; or
a WLAN performance parameter indicating performance associated with the WLAN in terms of data per unit of time.

7. The apparatus of claim 1, wherein the vehicle operation data includes one or more of vehicle communication data, vehicle operation data, vehicle positioning data, or path prediction data associated with the vehicle.

8. The apparatus of claim 1, wherein the processing system is further configured to detect that one or more update criteria associated with selection of the wireless network are satisfied, the one or more update criteria including one or more of expiration of a time interval, a change in the stationarity index value satisfying a threshold stationarity value, or a change in the one or more RAT parameters indicating a change in wireless communication quality of one or more of the WWAN or the WLAN.

9. The apparatus of claim 8, wherein, in accordance with detecting that the one or more update criteria are satisfied, the processing system is further configured to:
receive an updated version of the vehicle environmental context data;
receive an updated version of the vehicle operation data;
generate an updated version of the stationarity index value in accordance with the updated version of the vehicle environmental context data and the updated version of the vehicle operation data; and
perform, in accordance with the updated version of the stationarity index value, a switch decision to determine whether to switch from one of the WWAN or the WLAN to the other of the WWAN or the WLAN.

10. The apparatus of claim 1, wherein the processing system is further configured to:
input the stationarity index value and the one or more RAT parameters to a neural network; and
receive, in accordance with the stationarity index value and the one or more RAT parameters, an output of the neural network indicating the wireless network,
the wireless network selected further in accordance with the output.

11. The apparatus of claim 1, wherein the vehicle environmental context data includes signal phase and timing (SPaT) data and further includes sensor data associated with one or more sensors of the vehicle, the one or more sensors including at least one of a radar sensor of the vehicle, a light detection and ranging (LiDAR) sensor of the vehicle, or a camera of the vehicle.

12. The apparatus of claim 1, wherein the processing system is further configured to generate, in accordance with the vehicle environmental context data, an environmental context feature vector that includes a plurality of values each corresponding to a respective environmental context feature associated with the vehicle, the stationarity index value further in accordance with the environmental context feature vector.

13. A method of wireless network selection for a vehicle, the method comprising:
receiving vehicle environmental context data associated with an environment of the vehicle;
receiving vehicle operation data associated with one or more operating conditions of the vehicle;
generating, in accordance with the vehicle environmental context data and the vehicle operation data, a stationarity index value associated with the vehicle, the stationarity index value indicating whether the vehicle is predicted to be stationary for at least a threshold time interval to enable selection of a wireless network for communication by the vehicle; and
communicating using one of a wireless wide area network (WWAN) or a wireless local area network (WLAN) as the wireless network, the wireless network selected in accordance with the stationarity index value and further in accordance with one or more radio access technology (RAT) parameters.

14. The method of claim 13, wherein the stationarity index value is selected from a range of values between a first boundary value and an second boundary value, the first boundary value indicating that the vehicle is predicted to remain in motion for at least the threshold time interval, and the second boundary value indicating that the vehicle is predicted to remain stationary for at least the threshold time interval.

15. The method of claim 13, further comprising determining, in accordance with the stationarity index value and the one or more RAT parameters, a probability value associated with selection of the wireless network, the probability value from a range of values from a first value to a second value, the first value indicating selection of the WWAN as the wireless network, the second value indicating selection of the WLAN as the wireless network, and values between the first value and the second value associated with probabilistic selection of either the WWAN or the WLAN as the wireless network.

16. The method of claim 15, wherein, in accordance with the stationarity index value failing to exceed a threshold stationarity value, the probability value has a particular value that causes the vehicle to select the WWAN as the wireless network.

17. The method of claim 16, further comprising, in accordance with the stationarity index value exceeding the threshold stationarity value:
comparing the probability value to a reference value; and
outputting an indication of the wireless network to a communication subsystem of the vehicle, the indication having one of a first value indicating the WWAN in accordance with the probability value exceeding the reference value or a second value indicating the WLAN in accordance with the probability value failing to exceed the reference value.

18. A non-transitory computer-readable medium storing instructions executable by one or more processors to initiate, perform, or control operations for wireless network selection for a vehicle, the operations comprising:
receiving vehicle environmental context data associated with an environment of the vehicle;
receiving vehicle operation data associated with one or more operating conditions of the vehicle;
generating, in accordance with the vehicle environmental context data and the vehicle operation data, a stationarity index value associated with the vehicle, the stationarity index value indicating whether the vehicle is predicted to be stationary for at least a threshold time interval to enable selection of a wireless network for communication by the vehicle; and
communicating using one of a wireless wide area network (WWAN) or a wireless local area network (WLAN) as the wireless network, the wireless network selected in accordance with the stationarity index value and further in accordance with one or more radio access technology (RAT) parameters.

19. The non-transitory computer-readable medium of claim 18, wherein the operations further comprise detecting that one or more update criteria associated with selection of the wireless network are satisfied, the one or more update criteria including one or more of expiration of a time interval, a change in the stationarity index value satisfying a threshold stationarity value, or a change in the one or more RAT parameters indicating a change in wireless communication quality of one or more of the WWAN or the WLAN.

20. The non-transitory computer-readable medium of claim 19, wherein the operations further comprise, in accordance with detecting that the one or more update criteria are satisfied:
receiving an updated version of the vehicle environmental context data;
receiving an updated version of the vehicle operation data;
generating an updated version of the stationarity index value in accordance with the updated version of the vehicle environmental context data and the updated version of the vehicle operation data; and
performing, in accordance with the updated version of the stationarity index value, a switch decision to determine whether to switch from one of the WWAN or the WLAN to the other of the WWAN or the WLAN.
